(19) United States
(12) Patent Application Publication
(10) Pub. No.: US 2022/0144658 A1
(43) Pub. Date: May 12, 2022

(54) METHOD FOR PREPARING ALUMINUM FLUORIDE AND ALUMINUM OXIDE BY DECARBURIZATION AND SODIUM REMOVAL OF ALUMINUM ELECTROLYSIS CARBON RESIDUE

(71) Applicant: Zhengzhou University, Zhengzhou City (CN)

(72) Inventor: Xiping CHEN, Zhengzhou City (CN)

(73) Assignee: Zhengzhou University, Zhengzhou City (CN)

(21) Appl. No.: 17/515,642

(22) Filed: Nov. 1, 2021

(30) Foreign Application Priority Data
Nov. 11, 2020 (CN) 202011250785.X

(51) Int. Cl. C01F 7/50; C01F 7/30

(52) U.S. Cl. CPC C01F 7/50; C25C 3/22; C01F 7/30

(57) ABSTRACT

A method for preparing aluminum fluoride and aluminum oxide by decarburization and sodium removal of an aluminum electrolysis carbon residue is disclosed. The method includes: crushing the aluminum electrolysis carbon residue into fine particles not larger than 3 mm, adding decarburization agent into the carbon residue, mixing to obtain first mixture, adding the first mixture into a high-temperature furnace, conducting I-stage heating treatment in air atmosphere to obtain crude fluoride salt A; adding sodium removal agent into the crude fluoride salt A, mixing to obtain second mixture, adding the second mixture into high-temperature furnace, and conducting

II-stage heating treatment to obtain crude fluoride salt B; adding the crude fluoride salt B into stirring tank, adding industrial pure water, dissolving a sodium salt into water, and conducting solid-liquid separation to obtain precipitate C and sodium salt solution D; drying the precipitate C to obtain aluminum fluoride and aluminum oxide.

### TECHNICAL FIELD

The present disclosure relates to the technical field for recycling of aluminum electrolysis carbon residue, and more specifically, to a method for preparing aluminum fluoride and aluminum oxide by decarburization and sodium removal of an aluminum electrolysis carbon residue.

### BACKGROUND ART

During aluminum electrolysis process, due to the selective oxidation of carbon anodes, non-combusted particles fall off from the surface of anodes into electrolytic cells, and then enter into electrolyte to form carbon residue, also known as carbon dust, carbon slag or anode carbon dusting. The carbon residue is immersed in the electrolyte for a long period of time, and filled with electrolyte in its micropores, resulting in carbon residue containing about 30% of carbon and about 70% of fluoride salts, which is a secondary fluorine resource with a high added value. Currently, a flotation method or an incineration method is mainly adopted in the industry to separate fluoride salts from the carbon residue to obtain impure electrolyte and carbon powder, thus realizing the recycling of the carbon residue generating from aluminum electrolysis.

The patent CN 104499000 A discloses a method for treating aluminum electrolysis carbon residue by beneficiation, which includes the following steps: fishing out the carbon residue from an aluminum electrolytic cell, crushing and grinding to 20-60 meshes, adding water, a collecting agent and a foaming agent into the ground carbon residue to obtain an slurry; placing the slurry in a roughing flotation machine and two scavenging flotation machines in sequence for flotation, wherein the foam product scraped by the roughing flotation machine is carbon powder, and the material obtained from the second scavenging flotation machine is filtered, dried and calcined to obtain a cryolite product.

The patent CN 109759423 A discloses a method for comprehensive utilization of aluminum electrolysis carbon residue, which includes the following steps: (1) crushing and screening: subjecting carbon residue to a coarse crushing, a ball milling and a screening in turn to obtain a carbon residue powder; (2) flotation: putting the carbon residue powder into a flotation cell, and stirring to obtain a slurry; sequentially adding water glass as an inhibitor and coal oil as a collecting agent into the slurry for flotation; drying a foam product scraped by the flotation to obtain a carbon powder; (3) filtering: filtering the electrolyte discharged from the bottom stream of the flotation cell to obtain a filtrate; (4) dissolving: adding a mixed solution of 0.01-0.05 mol/L HNO₃ and 0.3-0.36 mol/L Al(NO₃)₃ into the filtrate, and reacting at 60-65° C. for 1-1.5 h to obtain a solid-liquid mixture, wherein aluminum reacts with fluorine to generate AlF₃(OH) precipitate, sodium and calcium are transformed to a mixed solution of sodium nitrate and calcium nitrate; (5) separation: subjecting the solid-liquid mixture to a solid-liquid separation to obtain a filter residue, wherein the main component of the filter residue is AlF₃(OH); (6) acid leaching: mixing the filter residue with a hydrofluoric acid solution with a pH of 0.1-0.3, and then reacting for 1-1.5 h to obtain a second solid-liquid mixture; (7) separation: subjecting the second solid-liquid mixture to a solid-liquid separation, to obtain AlF₃. In this method, aluminum nitrate is used to prepare aluminum fluoride, and this is because aluminum nitrate is easily dissolved into water to hydrolyze into nitric acid and aluminum hydroxide. However, aluminum nitrate is a dangerous goods and is high in price. Furthermore, when aluminum nitrate is used as a leaching agent and a fluorine deposition agent, the obtained aluminum fluoride has a low purity.

The patent CN 110144602 A discloses a process for treating aluminum electrolysis carbon residue, which specifically includes: placing an inclined incineration bed in a reaction furnace, wherein the incineration bed is provided with an electrolyte collection tank at its bottom; crushing aluminum electrolysis carbon residue, mixing with a combustion improver and weighing, dispersing the resulting mixture on the incineration bed; and then continuously introducing high-temperature air to the reaction furnace from the up end of the incineration bed, to make the carbon in the aluminum electrolysis carbon residue and combustion improver react with O₂ in the air; introducing a high-temperature flue gas generated in the reaction into a heat exchanger, conducting a heat exchange with ambient-temperature air introduced into the heat exchanger, and then entering an aluminum electrolysis flue gas purification system for treatment, and discharging after reaching emission standard; flowing a liquid electrolyte generated in the reaction from the inclined incineration bed into the electrolyte collection tank, and discharging the liquid electrolyte from the electrolyte collection tank after reaching the preset liquid level, and injecting the liquid electrolyte into a solidification mold.

The patent CN 107604383 A discloses a method for extracting electrolyte from carbon residue by a smelting process, which is conducted as follows: heating carbon residue to 1250-1300° C. in a smelting furnace, smelting the electrolyte in the carbon residue into liquid state, keeping carbon floating on the surface of the electrolyte liquid, removing the floating carbon, discharging the electrolyte, cooling and returning the electrolyte to an aluminum electrolysis process for use.

However, the carbon powder, which is separated from the filtrate by a flotation method, still contains part of fluorine, so that no harmless carbon powder is obtained. The carbon powder after flotation is still a hazardous waste, and needs to be subjected to a secondary treatment. In addition, the obtained fluoride precipitate after flotation contains many impurities and could not be regarded as a product; that is, the flotation method does not realize thorough harmless treatment of the carbon residue. The incineration method for treating carbon residue could result in electrolyte with higher quality than that resulting from the flotation method. Nevertheless, the carbon powder obtained by the incineration method has similar quality to that of the carbon powder resulting from the flotation method, and no harmless carbon powder is obtained, either.

### SUMMARY

An object of the present disclosure is to provide a method for preparing aluminum fluoride and aluminum oxide by decarburization and sodium removal of aluminum electrolysis carbon residue, to solve the technical problems in the prior art that it is impossible to realize harmless treatment on carbon powder and the production cost of aluminum fluoride is high.

As used herein, the singular forms “a”, “an” and “the” are intended to include the plural forms as well, unless otherwise specified.

In order to achieve the above object, the present disclosure provides the following technical solutions:

A method for preparing aluminum fluoride and aluminum oxide by decarburization and sodium removal of aluminum electrolysis carbon residue, including the following steps:

1) crushing the aluminum electrolysis carbon residue into fine particles not larger than 3 mm, adding a decarburization agent into the carbon residue, mixing to obtain a first mixture, adding the first mixture into a high-temperature furnace, and conducting a I-stage heating treatment in air, to obtain a crude fluoride salt A;

2) adding a sodium removal agent into the crude fluoride salt A, mixing to obtain a second mixture, adding the second mixture into a high-temperature furnace, and conducting a II-stage heating treatment, to obtain a crude fluoride salt B;

3) adding the crude fluoride salt B into a stirring tank, adding industrial pure water thereto, dissolving a sodium salt into water, and conducting a solid-liquid separation to obtain a precipitate C and a sodium salt solution D; and

4) drying the precipitate C to obtain a mixture of aluminum fluoride and aluminum oxide, concentrating the sodium salt solution D by evaporating to obtain a sodium salt, and returning evaporated condensate water to the stirring tank for recycling.

In some embodiments, the method further includes the following steps: collecting a flue gas generated in the I-stage heating treatment and the II-stage heating treatment, introducing the flue gas into an aluminum hydroxide reactor, reacting HF in the flue gas with aluminum hydroxide to obtain aluminum fluoride.

In some embodiments, the decarburization agent is at least one selected from the group consisting of biochar, engine oil, and starch.

In some embodiments, the decarburization agent is added in an amount which is 0.1-0.5 times the mass of carbon in the carbon residue.

In some embodiments, the sodium removal agent is at least one selected from the group consisting of aluminum sulfate, aluminum acetate, aluminum oxalate, aluminum nitrate, and aluminum hydroxide.

In some embodiments, the sodium removal agent is added in an amount which is 1-3 times the mass of sodium in the carbon residue.

In some embodiments, the industrial pure water is added in an amount which is 2-5 times of the crude fluoride salt B.

In some embodiments, the I-stage heating treatment and the II-stage heating treatment are independently conducted at a temperature not lower than 700° C. and lower than the melting points of fluoride salts and sodium salts.

In some embodiments, the I-stage heating treatment is hold for at least 2 h, and the II-stage heating treatment is hold for at least 1-3 h.

Compared with the prior art, the present disclosure has the following beneficial effects:

The present disclosure discloses a method for preparing aluminum fluoride and aluminum oxide by decarburization and sodium removal of aluminum electrolysis carbon residue, which is a two-stage heating combined treatment process. According to this method, aluminum electrolysis carbon residue is subjected to a decarbonization treatment, during which carbon is oxidated and combusted to obtain a crude fluoride salt A; the crude fluoride salt A is then subjected to a sodium removal treatment, during which the crude fluoride salt A reacts with a sodium removal agent to obtain a crude fluoride salt B; the crude fluoride salt B is subjected to a water leaching to separate aluminum fluoride/oxide and a sodium salt, resulting in pure aluminum fluoride and aluminum oxide as a final product, and a sodium salt as a byproduct, thereby realizing the total recycling of carbon residue, and obtaining a product with high purity. This method has advantages such as no waste residue and waste water generated in the whole process, and wide sources of the decarburization agent and the sodium removal agent, low production cost, and simple industrial implementation.

### DETAILED DESCRIPTION OF THE EMBODIMENTS

The following examples are intended to illustrate the present disclosure and are not intended to limit the scope of the present disclosure. Unless otherwise specified, the technical means used in the examples are conventional means well known to those skilled in the art. The test methods in the following examples are conventional, unless otherwise specified.

The aluminum electrolysis carbon residue used in the examples of the present disclosure is taken from an aluminum electrolysis cell of a smelter in China, and mainly consists of the carbon particles that falls from the surface of prebaked anodes during oxidation combustion process. The decarburization agent is a compound or mixture with a combustion point lower than carbon residue, a composition of C, C—H or C—H—O, which is a solid or a liquid at ambient temperature, and is nontoxic and harmless, and contains less than 2% of silicon, iron, phosphorus and sulfur impurities, and it is preferably biochar, engine oil or starch. The sodium removal agent is an aluminum salt stable at ambient temperature, and is preferably selected from the group consisting of aluminum sulfate, aluminum acetate, aluminum oxalate and aluminum hydroxide.

### EXAMPLE 1

(1) 1000 g of carbon residue was crushed into fine particles not larger than 3 mm, which was analyzed to have a carbon content of 35.4%. 35.4 g of a decarburization agent (7.08 g of engine oil and 28.32 g of biochar) was added thereto, and mixed to obtain a first mixture. The first mixture was added to a high-temperature furnace, and heated at 700° C. for 4 h, during which carbon was oxidized and combusted, obtaining about 645 g of a crude fluoride salt A.

(2) The crude fluoride salt A was ground and analyzed to have a sodium content of 31.5%. 203 g of aluminum sulfate was added thereto and mixed to obtain a second mixture. The second mixture was added to a high-temperature furnace and heated at 750° C. for 3 h, during which the crude fluoride salt A reacted with a sodium removal agent, obtaining about 848 g of a crude fluoride salt B.

(3) The crude fluoride salt B was added into a stirring tank, 2544 g of industrial pure water was added thereto, and a sodium salt was dissolved into water. The resulting mixture was subjected to a solid-liquid separation, obtaining about 374 g of a precipitate C and a sodium salt solution D.

(4) The precipitate C was dried at 120° C. to obtain a mixture of aluminum fluoride and aluminum oxide, wherein the content of impurities in the mixture met the requirements of AF-2 in GBT4292-2017 standard and AO-2 in GBT24487-2009 standard, respectively. The recovery rate of aluminum was 99.90%, and the recovery rate of fluorine was 99.45%. The solution D was concentrated by evaporating, to obtain a sodium salt, and the obtained evaporated condensate water returned to the stirring tank for recycling.

(5) A flue gas generated in the I-stage heating in step (1) and the II-stage heating in step (2) was collected and introduced into an aluminum hydroxide reactor, and HF in the flue gas reacted with aluminum hydroxide to obtain aluminum fluoride, wherein the quality of aluminum fluoride met the requirement of AF-2 in GBT4292-2017 standard, and the recovery rate of fluorine was higher than 99.50%.

### EXAMPLE 2

(1) 1000 g of carbon residue was crushed into fine particles not larger than 3 mm, which was analyzed to have a carbon content of 30.5%, 91.5 g of a decarburization agent (64.05 g of engine oil, 27.45 g of starch) was added thereto and mixed to obtain a first mixture. The first mixture was added to a high-temperature furnace, and heated at 745° C. for 3 h, during which carbon was oxidized and combusted, obtaining about 695 g of a crude fluoride salt A.

(2) The crude fluoride salt A was ground and analyzed to have a sodium content of 33.0%. 460 g of aluminum acetate was added thereto and mixed to obtain a second mixture. The second mixture was added to a high-temperature furnace and heated at 790° C. for 1 h, during which the crude fluoride salt A reacted with a sodium removal agent, obtaining about 1150 g of a crude fluoride salt B.

(3) The crude fluoride salt B was added into a stirring tank, 2300 g of industrial pure water was added thereto, and a sodium salt was dissolved into water. The resulting mixture was subjected to a solid-liquid separation, obtaining about 510 g of a precipitate C and a sodium salt solution D.

(4) The precipitate C was dried at 260° C. to obtain a mixture of aluminum fluoride and aluminum oxide, wherein the content of impurities in the mixture met the requirements of AF-2 in GBT4292-2017 standard and AO-2 in GBT24487-2009 standard, respectively. The recovery rate of aluminum was 99.92%, and the recovery rate of fluorine was 99.51%. The solution D was concentrated by evaporating to obtain a sodium salt, and the obtained evaporated condensate water returned to the stirring tank for recycling.

(5) A flue gas generated in the I-stage heating in step (1) and the II-stage heating in step (2) was collected and introduced into an aluminum hydroxide reactor, and HF in the flue gas reacted with aluminum hydroxide to obtain aluminum fluoride, wherein the quality of aluminum fluoride met the requirement of AF-2 in GBT4292 -2017 standard, and the recovery rate of fluorine was higher than 99.53%.

### EXAMPLE 3

(1) 1000 g of carbon residue was crushed into fine particles not larger than 3 mm, which was analyzed to have a carbon content of 38.0%. 190 g of a decarburization agent (76 g of starch, 114 g of biochar) was added thereto and mixed to obtain a first mixture. The first mixture was added to a high-temperature furnace and heated at 790° C. for 2 h, during which carbon was oxidized and combusted, obtaining about 620 g of a crude fluoride salt A.

(2) The crude fluoride salt A was ground and analyzed to have a sodium content of 32.3%. 600 g of aluminum oxalate was added thereto and mixed to obtain a second mixture. The second mixture was added to a high-temperature furnace and heated at 770° C. for 2 h, during which the crude fluoride salt A reacted with a sodium removal agent, obtaining about 1220 g of a crude fluoride salt B.

(3) The crude fluoride salt B was added into a stirring tank, 6100 g of industrial pure water was added thereto, and a sodium salt was dissolved into water. The resulting mixture was subjected to a solid-liquid separation, obtaining about 680 g of a precipitate C and a sodium salt solution D.

(4) The precipitate C was dried at 350° C. to obtain a mixture of aluminum fluoride and aluminum oxide, wherein the content of impurities in the mixture met the requirements of AF-2 in GBT 4292 -2017 standard and AO-2 in GBT24487-2009 standard, respectively. The recovery rate of aluminum was 99.93%, and the recovery rate of fluorine was 99.55%. The solution D was concentrated by evaporating, to obtain a sodium salt, and the obtained evaporated condensate water returned to the stirring tank for recycling.

(5) A flue gas generated in the I-stage heating in step (1) and the II-stage heating in step (2) was collected and introduced into an aluminum hydroxide reactor, and HF in the flue gas reacted with aluminum hydroxide to obtain aluminum fluoride, wherein, the quality of aluminum fluoride met the requirement of AF-2 in GBT4292-2017 standard, and the recovery rate of fluorine was higher than 99.53%.

### EXAMPLE 4

(1) 1000 g of carbon residue was crushed into fine particles not larger than 3 mm, which was analyzed to have a carbon content of 33%. 132 g of a decarburization agent (39.6 g of engine oil, 13.2 g of starch and 79.2 g of biochar) was added thereto and mixed to obtain a first mixture. The first mixture was added to a high-temperature furnace and heated at 730° C. for 3.5 h, during which carbon was oxidized and combusted, obtaining about 670 g of a crude fluoride salt A.

(2) The crude fluoride salt A was ground and analyzed to have a sodium content of 34%. 700 g of aluminum sulfate was added thereto and mixed to obtain a second mixture. The second mixture was added to a high-temperature furnace and heated at 760° C. for 2.5 h, during which the crude fluoride salt A reacted with a sodium removal agent, obtaining about 1370 g of a crude fluoride salt B.

(3) The crude fluoride salt B was added into a stirring tank, 5480 g of industrial pure water was added thereto, and a sodium salt was dissolved into water. The resulting mixture was subjected to a solid-liquid separation, obtaining about 763 g of a precipitate C and a sodium salt solution D.

(4) The precipitate C was dried at 300° C. to obtain a mixture of aluminum fluoride and aluminum oxide, wherein the content of impurities in the mixture met the requirements of AF-2 in GBT 4292-2017 standard and AO-2 in GBT24487-2009 standard, respectively. The recovery rate of aluminum was 99.92%, and the recovery rate of fluorine was 99.49%. The solution D was concentrated by evaporating to obtain a sodium salt, and the obtained evaporated condensate water returned to the stirring tank for recycling.

(5) A flue gas generated in the I-stage heating in step (1) and the II-stage heating in step (2) was collected and introduced into an aluminum hydroxide reactor, and HF in the flue gas reacted with aluminum hydroxide to obtain aluminum fluoride, wherein the quality of aluminum fluoride met the requirement of AF-2 in GBT4292-2017 standard, and the recovery rate of fluorine was higher than 99.54%.

The above examples are only preferred embodiments of the present disclosure, and are merely intended to describe the present disclosure, not to limit the present disclosure. According to the technical content of the present disclosure, those skilled in the art would readily obtain other embodiments by replacement and modification. Accordingly, any modification and improvement made based on the principle of the present disclosure should fall within the scope of the present disclosure.

What is claimed is:

1. A method for preparing aluminum fluoride and aluminum oxide by decarburization and sodium removal of aluminum electrolysis carbon residue, comprising:
crushing the aluminum electrolysis carbon residue into fine particles not larger than 3 mm, adding a decarburization agent into the carbon residue, mixing to obtain a first mixture, adding the first mixture into a high-temperature furnace, and conducting a I-stage heating treatment in an air atmosphere, to obtain a crude fluoride salt A;
adding a sodium removal agent into the crude fluoride salt A, mixing to obtain a second mixture, adding the second mixture into a high-temperature furnace, and conducting a II-stage heating treatment, to obtain a crude fluoride salt B;
adding the crude fluoride salt B into a stirring tank, adding industrial pure water thereto, dissolving a sodium salt into water, and conducting a solid-liquid separation to obtain a precipitate C and a sodium salt solution D; and
drying the precipitate C to obtain a mixture of aluminum fluoride and aluminum oxide, concentrating the sodium salt solution D by evaporating to obtain a sodium salt, and returning evaporated condensate water to a stirring tank for recycling.

2. The method of claim 1, wherein the method further comprises the following steps: collecting a flue gas generated in the I-stage heating treatment and the II-stage heating treatment, introducing the flue gas into an aluminum hydroxide reactor, and reacting HF in the flue gas with aluminum hydroxide to obtain aluminum fluoride.

3. The method of claim 1, wherein the decarburization agent is at least one selected from the group consisting of biochar, engine oil, and starch.

4. The method of claim 1, wherein the decarburization agent is added in an amount which is 0.1-0.5 times the mass of carbon in the carbon residue.

5. The method of claim 1, wherein the sodium removal agent is at least one selected from the group consisting of aluminum sulfate, aluminum acetate, aluminum oxalate, aluminum nitrate, and aluminum hydroxide.

6. The method of claim 1, wherein the sodium removal agent is added in an amount which is 1-3 times the mass of sodium in the carbon residue.

7. The method of claim 1, wherein the industrial pure water is added in an amount which is 2-5 times of the crude fluoride salt B.

8. The method of claim 1, wherein the I-stage heating treatment and the II-stage heating treatment are independently conducted at a temperature not lower than 700° C. and lower than the melting points of fluoride salts and sodium salts.

9. The method of claim 1, wherein the I-stage heating treatment is hold for at least 2 h and the II-stage heating treatment is hold for at least 1-3 h.
